(19) United States
(12) Patent Application Publication
(10) Pub. No.: US 2026/0201268 A1
(43) Pub. Date: Jul. 16, 2026

(54) PROCESSING METHOD FOR POULTRY OIL

(71) Applicant: Kai-neng HWANG, Tainan (CN)

(72) Inventors: Kai-neng HWANG, Tainan (CN); Huei-ping TANG, Tainan (CN)

(21) Appl. No.: 19/564,083

(22) Filed: Mar. 11, 2026

Related U.S. Application Data
(63) Continuation-in-part of application No. 15/359,018, filed on Nov. 22, 2016, now abandoned.

(30) Foreign Application Priority Data
Jan. 27, 2016 (TW) 105102528
May 30, 2016 (TW) 105116870

(51) Int. Cl. C11B 3/00; A23D 9/007; A23D 9/04; C11B 3/16; C11B 7/00

(52) U.S. Cl. CPC C11B 3/001; A23D 9/007; A23D 9/04; C11B 3/008; C11B 3/16; C11B 7/0075

(57) ABSTRACT

The invention discloses a processing method for poultry oil. The method comprises: placing a crude poultry oil at a predetermined temperature for forming a mixture containing liquid-type oil and solid-type oil; and harvesting the liquid-type oil from the mixture at the predetermined temperature. The predetermined temperature is set between 13° C. and 17° C., and the tolerance for the temperature measurement is ±2° C. Accordingly, compared to the crude poultry oil, the processed poultry oil has a good commercial appearance without solid precipitation at room temperature. The obtained liquid-type oil (liquid glyceride fraction) has a fatty acid composition that is highly similar to an ideal dietary fatty acid ratio proposed by Hayes, where saturated fatty acids (S):monounsaturated fatty acids (M):polyunsaturated fatty acids (P)=1:1.5:1.

### CROSS-REFERENCE TO RELATED APPLICATIONS

This application is a continuation-in-part application of U.S. application Ser. No. 15/359,018, filed on Nov. 22, 2016, now pending, which claims the benefit of priority from Application No. 105102528 filed in TAIWAN on Jan. 27, 2016 and Application No. 105116870 filed in TAIWAN on May 30, 2016. The content of the aforementioned application, including any intervening amendments made thereto, is incorporated herein by reference in its entirety.

### TECHNICAL FIELD

This application relates to a processing method for poultry oil to obtain a processed poultry oil from which a liquid glyceride fraction is obtained, the liquid glyceride fraction remaining liquid at room temperature (in the α-crystalline form), being free of flocculent sedimentation, and exhibiting a preferable appearance. The processed chicken oil showed different fatty acids ratio in comparison with the original crude chicken oil. Specifically, the obtained liquid fraction possesses a fatty acid composition highly similar to an ideal dietary fatty acid ratio proposed by Hayes, namely: saturated fatty acids (S):monounsaturated fatty acids (M):polyunsaturated fatty acids (P)=1:1.5:1[1].

### BACKGROUND

In general, the fat tissue of chicken can be fried or boiled, eliminate the dregs or water, to get the traditional chicken oil known as the crude chicken oil.

However, traditionally, the crude chicken oil seldom serves as a dietary oil. It appeared to has some solid-type oil (β-form) precipitate (flocculent sedimentation) at room temperature, and the precipitate can usually lead to an unfavorable impression in commerce. Moreover, the crude chicken oil appeared to have the saturated fatty acid (SFA):monosaturated fatty acid (MUFA):poly unsaturated fatty acid (PUPA), about 1:1.5:0.6 (Wei et al., Food Science 2012; 33 (16): 188-193., Rondelli et al., Brazilian Journal of Poultry Science. 2004; 6 (3): 171-175). The fatty acids of the crude chicken oil showed little benefits to public health. Therefore, although chicken is the most consumed meat in the world, crude chicken oil is usually used as a feed for livestock instead of a source of dietary oil, and the situation of other kinds of crude poultry oil is quite similar.

Taking chicken oil as an example, chicken fat may be processed by frying or boiling. After removal of residues and moisture, conventional crude chicken oil is obtained. However, over the past several decades, researchers such as Nagaii, Hammet, Fogila, Lee, Vanhoutte, and Arnaud have demonstrated that conventional multi-temperature crystallization or continuous crystallization methods are unable to alter the saturated fatty acid:monounsaturated fatty acid:polyunsaturated fatty acid (S:M:P) ratio of chicken fat [2-7].

Meanwhile, apart from multi-temperature (continuous) crystallization, isothermal (supersaturated) crystallization has not been tested in the processing of chicken oil [8]. In addition, crude chicken oil has rarely been used as a dietary oil. At room temperature, stearin (solid fat in the β-crystalline form) tends to precipitate, resulting in an undesirable appearance in commercial applications. Although chicken oil has been studied for decades, no significant advantages or distinguishing features have been identified to date.

Although chicken meat is the most widely consumed meat globally, chicken oil has not been widely accepted as a dietary oil. Other animal fats exhibit similar limitations. However, it has been found that the fatty acid composition of chicken oil closely resembles the ideal dietary fatty acid ratio proposed by Hayes. This observation prompted further investigation into methods for improving chicken oil so as to render its fatty acid composition more consistent with the ideal fatty acid ratio.

In light of this, it is necessary to improve the appearance, to provide a processing method for crude poultry oil such as crude chicken oil, to obtain a processed poultry oil with few or mostly none flocculent sedimentation at room temperature. Thereby, a liquid glyceride fraction is obtained which has a fatty acid composition closer to the ideal dietary fatty acid ratio proposed by Hayes and/or the fatty acid profile of human adipose tissue. Furthermore, it will be another plus to show the processed chicken oil with improved fatty acids ratio, and to benefit more to the public health.

### SUMMARY

An object of the disclosure is to provide a method to treat the crude poultry oil to get a processed poultry oil with better appearance, liquid and none flocculent sedimentation at room temperature, thereby obtaining a liquid glyceride fraction having a fatty acid composition closer to an ideal dietary fatty acid ratio proposed by Hayes and/or a fatty acid profile of human adipose tissue [9].

Technical solutions of the present disclosure are described as follows.

A processing method for poultry oil, comprising:
putting a crude poultry oil at a predetermined low constant temperature;
cooling the crude poultry oil at an average rate of −0.5° C. per hour to prevent premature crystallization during the cooling process;
upon reaching the predetermined temperature, maintaining the crude poultry oil at the predetermined low constant temperature to initiate crystallization, thereby forming a liquid and solid mixed oil comprising liquid-type oil and solid-type oil; and
collecting the liquid-type oil;
wherein the predetermined low constant temperature is set between 13° C. and 17° C., with the tolerance of ±2° C.

In some embodiments, the temperature is set at 13° C. or 17° C., with the tolerance of ±0.5° C.

In some embodiments, the crude poultry oil is stirred at the temperature to help the formation of liquid/solid suspended crude poultry oil. For example, the crude poultry oil was stirred at 5 rpm for 12 hours or longer to help the formation of the liquid and solid mixed oil.

In some embodiments, the liquid-type oil in above cold treated crude poultry oil was harvested. For example, the treated crude poultry oil was loaded in a filter bag (pore size 0.05 mm), centrifuged at 80 rpm for 20 minutes at the predetermined low temperature to get the liquid-type oil. This liquid-type oil is also known as the processed poultry oil. This liquid-type oil has a fatty acid composition closely resembling an ideal dietary fatty acid ratio proposed by Hayes (saturated fatty acids:monounsaturated fatty acids:polyunsaturated fatty acids (S:M:P)=1:1.5:1), a fatty acid profile of human adipose tissue (S:M:P=1:1.9:0.7), or a combination thereof.

### BRIEF DESCRIPTION OF THE DRAWINGS

The invention will be more comprehensive with the illustration, and not limitative of the present invention.

FIG. 1 shows crude chicken oil (cloudy sediment) on the right hand side, and the processed chicken oil (clear or transparency) on the left hand side.

Analysis of the fatty acids of the chicken oil is done as the FDA Taiwan suggested method (NFS-0961800343), using an HP-88 column (Agilent, 100 m×0.25 mmI.D., 0.2 μm film thickness) with a FID detector, by Shimatzu GC Model-2010. A typical example of the chicken oil analyzed by gas chromatography (GC) is illustrated at FIG. 2.

FIG. 3 illustrates a cooling process of the present disclosure. In this experiment, the chicken oil is continuously stirred during cooling to prevent nucleation until the temperature reached 13° C. Thereafter, stirring is stopped, and the chicken oil is held at 13° C. to allow isothermal crystallization.

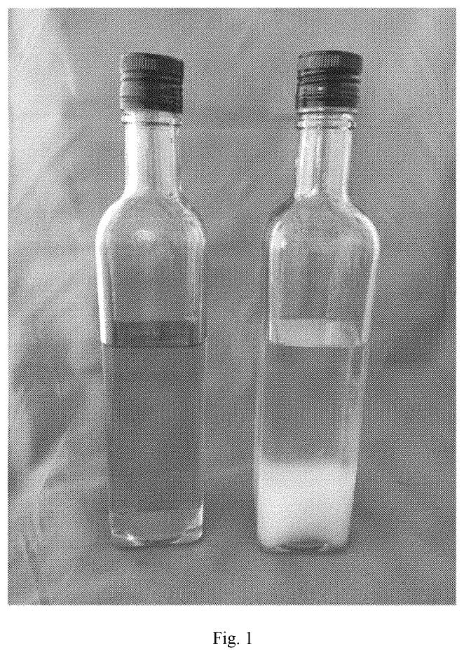

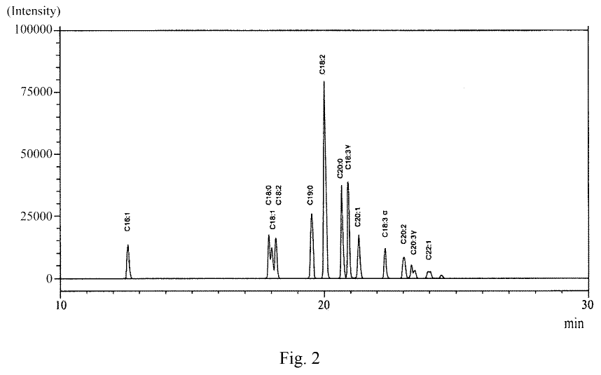

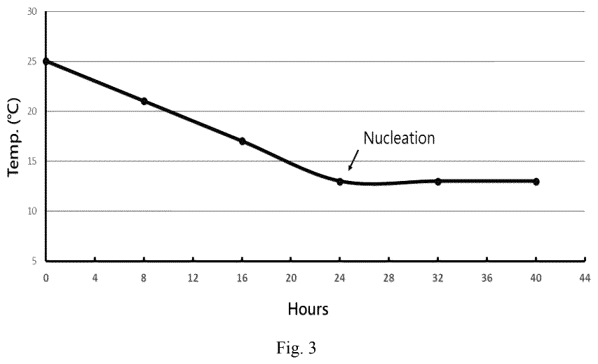

### DETAILED DESCRIPTION OF EMBODIMENTS

To get the poultry oil, the fatty tissues of poultry were fried or boiled, get rid of the impurities of dregs or water, to get the crude poultry oil. This process can be appreciated by a person having ordinary skill in the art. The poultry mentioned in this invention is defined to consist of the chicken, duck, goose, and ostrich, and the chicken oil is taken as an example for the detailed illustration hereinafter.

In this invention, an example of 50 liters of crude chicken oil was put in a stainless pot (diameter×height=60×85 cm). Respectively, the pot was put in a cold room at the temperature 13° C. or 17° C., with the tolerance of ±2° C. The crude chicken oil was cooled through air at an average rate of −0.5° C. per hour, forming an insulating layer. Due to the solid-type oil formed on the pot wall would act as a good thermal insulator and interfere the phase transform of other oil, therefore, the oil was stirred with a paddle attached with silicon pads, at the speed of 5 rpm for 12 hours or longer. This stirring process ensures thermal equilibrium and prevents premature crystallization during cooling, thereby preventing the solid-type oil formed on the pot wall, and assure the evenly formation of the solid and liquid mixed oil.

After the supersaturated fat has been cooled to a predetermined temperature, it is allowed to stand at this constant temperature to initiate isothermal crystallization (nucleation). Upon completion of crystallization, the liquid glyceride fraction (liquid portion, olein) is separated from the stearin fraction (solid fat fraction).

The liquid-type chicken oil was then harvested from above mixed oil. For example, the mixed oil can be stood for 12 hours or longer at the predetermined low temperature to precipitate the solid-type oil, and to decant or to collect the upper liquid-type oil directly. In this invention, the low temperature treated oil is loaded in a filter bag to filter to get the processed chicken oil. An effectively example was to centrifuging the oil at 80 rpm for 20 minutes, using a nylon bag with pore size 0.05 mm, to harvest the liquid-type oil, known as the processed chicken oil. This cold treatment method and the liquid oil harvest process not only good for the chicken oil but also good for the duck, goose, and ostrich oil.

In order to understand the efficacy of the cold treatment method, and the fatty acids composition (SFA:MUFA:PUPA) of the processed chicken oils, following trials are done.

Respectively, the crude chicken oils are placed in a cold room with the temperature set at 25±0.5° C. (group A0), 21±0.5° C. (group A1), 17±0.5° C. (group A2), 13±0.5° C. (group A3) and 9±0.5° C. (group A4), and stirring constantly at 5 rpm for 12 hours or longer. After cooling is completed, the crude chicken oils are allowed to remain at the respective low constant temperatures (21° C., 17° C., 13° C., or 9° C.) to initiate crystallization.

Respectively, the cold treated oil in group A0-A4 were collected and centrifuged at 80 rpm for 20 minutes, using a nylon bag with pore size 0.05 mm, and the liquid-type oils, the processed chicken oils were collected and analyzed by GC.

To evaluate the effectiveness of the supersaturated crystallization method, the fatty acid composition (saturated fatty acids:monounsaturated fatty acids: polyunsaturated fatty acids (S:M:P)) of the processed chicken oil is analyzed. Crude chicken oil samples are placed in a cold room and cooled at a rate of 0.5° C. per hour using circulated air. During cooling, the crude chicken oil samples are stirred at 1-60 rpm to prevent premature crystallization before reaching the target temperature. Thereafter, the samples are held at the constant temperature to initiate crystallization. The set temperatures are 25±0.5° C. (group A0), 21±0.5° C. (group A1), 17±0.5° C. (group A2), 13±0.5° C. (group A3), and 9±0.5° C. (group A4). Six independent batches are tested for each group to obtain average values.

Following isothermal crystallization, the A0-A4 group oil samples are centrifuged at 1-120 rpm for 20 minutes at the constant temperatures and separated using multiple nylon filter bags with pore sizes ranging from 0.8 mm to 0.05 mm. The resulting liquid glyceride fractions are collected, analyzed, and subjected to gas chromatography (GC).

Results of the fatty acids analysis of the processed chicken oil was tabulated on Table 1.

TABLE 1

| | Temperature | Recovery rate | Fatty acids ratio |
|---|---|---|---|
| Group | (° C.) | (%) | (SFA:MUFA:PUPA) |
| A0 | 25 ± 0.5 | 100 | 1:1.5:0.6 |
| A1 | 21 ± 0.5 | 91 ± 5 | 1:1.6:0.7 |
| A2 | 17 ± 0.5 | 84 ± 7 | 1:1.8:0.8 |
| A3 | 13 ± 0.5 | 56 ± 6 | 1:1.6:0.9 |
| A4 | 9 ± 0.5 | 0 | ND |

The recovery rate (%) of the processed chicken oil is weights compared between the processed chicken oil to the crude chicken oil, as shown on TABLE 1. There was none liquid oil collected in the 9° C.-treated oil, and the fatty acids was none detected. The melting point (M.P.) or solidification point of the obtained liquid glyceride fractions, as determined by testing, were 21° C., 17° C. and 13° C., respectively.

The fatty acid ratios of the liquid glyceride fractions in each group are compared with the Hayes ratio and the human adipose tissue ratio using a weighted method. The results are scored and summarized in Table 2.

Table 2 shows a scoring comparison between the liquid glyceride fractions and the Hayes ratio as well as the human adipose tissue ratio. The Hayes ratio and the human adipose tissue ratio are both set as reference scores of 100, and the liquid glyceride fraction samples are compared. A difference of less than 5 points is considered not significant. No significant difference is observed between group A0 and group A1, whereas groups A2 and A3 exhibits significant differences compared with group A0.

### CONCLUSION

The results shown in Table 2 indicate that the liquid glyceride fractions having melting points of 17±0.5° C. and 13±0.5° C. are closer to the Hayes ratio and the human adipose tissue ratio than those of group A0.

TABLE 2

| | | Hayes ratio | Human ratio |
|---|---|---|---|
| Group | M.P | 1 :1.5:1 | 1 : 1.9: 0.7 |
| A0 | 24° C. | 75 | 77 |
| A1 | 21° C. | 77 | 77 |
| A2 | 17° C. | 87 | 94 |
| A3 | 13° C. | 83 | 87 |
| A4 | ND | NA | NA |

The fatty acids ratio of the crude chicken oil (1:1.5:0.6) was compared with the processed oils, and the fatty acids ratios ingroups A2, A3 are significantly different from the crude chicken oil (Anova, p<0.05). These two oils also are similar to the fatty acid ratio (SFA:MUFA:PUPA=1:1.5:1) suggested by Hayes et al. (Asia Pac J Clin Nutr. 2002; 11 Suppl 7: S394-400).

According to the fatty acids analysis in the above, it seems that a part of the crude chicken oil with SFA or MUFA, with palmitic acid and/or oleic acid, tends to transform to the β-form (solid-type oil) at low temperature (between 13° C. and 17° C.). However, most of the oil with PUFA remained in α-form (liquid-type oil). Such phenomena seemed lead the processed chicken oil to have different fatty acids ratio with higher PUFA then the crude chicken oil.

Furthermore, Simopoulos suggested that the good essential fatty acids ratio for n-6:n-3 is between 10:1 and 25:1 (Simopoulos et al. Poult Sci. 2000 July; 79 (7): 961-70). The essential fatty acids ratio of n-6:n-3 of the processed chicken oil in group A3 is 12:1, and it meets the ratio suggested by Simopoulos. According to Simopoulos' report, the n-3 fatty acids show benefits in prevention and management of cardiovascular disease.

In conclusion, through the processing method for poultry oil, according to the present disclosure, the processed poultry oil showed none flocculent or none precipitate at room temperature. This transparency and none flocculent appearance is good for the commercial purposed. Furthermore, the processed chicken oil in the present disclosure also have a different fatty acids ratio from the crude chicken oil, and this fatty acids shift of the processed chicken oil has healthy benefits as Hayes and Simopoulos reported. Apparently, this invention opens a new gate for the utilization of the processed chicken oil as a healthy dietary oil.

Although the invention has been described in detail with references to its presently preferable embodiment, it will be understood by one of ordinary skill in the art that various modifications can be made without departing from the spirit and the scope of the invention, as set forth in the appended claims.

### REFERENCES

1. K. C. Hayes, Dietary fat and heart health: in search of the ideal fat. Asia Pac. J. Clin. Nutr. (2002), 11, S394-400).
2. Y Naigai, The processing method for chicken fat. (1971) S46-31880 JP
3. W. Hammet et al.: Trends in edible oil Fractionation. Trends Food Sci. Technol. (1995), 6, 121-126.
4. T A Fogila, Solvent fractionation of menhaden oil and partially hydrogenated menhaden oil for making lipis compositions enriched in unsaturated fatty acid containing triacylglycerols, U.S. Pat. No. 6,492,537B2 (2002)
5. K. T. Lee et al., Fractionation of chicken fat triacylglycerols: Synthesis of structured lipids with immobilized lipase. J. Food Sci. (2000), 65 (5). 826-831
6. B Vanhoutte et al., monitoring milk fat fractionation: Filtration properties and crystallization kinetics, Journal of the American Oil Chemists' Society, (2003), 80, 213-218
7. E. Arnaud et al., Characterization of chicken fat dry fractionation at pilot scale, European Journal of Lipid Science and Technology, (2004), 106, 591-598.
8. R B Hammond et al., Nucleation mechanism and kinetics from the analysis of polythermal crystallisation data: Methyl stearate from kerosene solutions, Cryst Eng Comm, (2014), 16 (6), 974-991.
9. J J Hernandez-Morante et al., Dehydroepiandrosterone-Sulfate Modifies Human Fatty Acid Composition of Different Adipose Tissue Depots, Obes Surg, (2011), 21, 102-111

What is claimed is:

1. A processing method for poultry oil, comprising:
placing a crude poultry oil at a predetermined temperature;
cooling the crude poultry oil at an average rate of −0.5° C. per hour to prevent premature crystallization during cooling;
upon reaching the predetermined temperature, maintaining the crude poultry oil at the predetermined temperature to initiate crystallization, thereby forming a mixture containing liquid-type oil and solid-type oil; and
harvesting the liquid-type oil from the mixture at the predetermined temperature, wherein the predetermined temperature is set between 13° C. and 17° C., and the tolerance for the temperature measurement is ±2° C.

2. The processing method for poultry oil as claimed in claim 1, wherein the predetermined temperature is set at 13° C., and the tolerance for the temperature measurement is ±0.5° C.

3. The processing method for poultry oil as claimed in claim 1, wherein the predetermined temperature is set at 17° C., and the tolerance for the temperature measurement is ±0.5° C.

4. The processing method for the poultry oil as claimed in claim 1, wherein the liquid-type oil is harvested by filtering out the solid-type oil of the mixture at the predetermined temperature.

5. The processing method for poultry oil as claimed in claim 4, wherein filtering out the solid-type oil comprises loading the mixture in a filter bag then centrifuging at 80 rpm for 20 minutes to collect the liquid-type oil.

6. The processing method for the poultry oil as claimed in claim 1, wherein the liquid-type oil is harvested by standing the mixture for a predetermined period of time to precipitate the solid-type oil, and to collect directly or by decantation the upper liquid-type oil.

7. The processing method for the poultry oil as claimed in claim 6, wherein the predetermined period of time is at least 12 hours.

8. The processing method for poultry oil as claimed in claim 1, the crude poultry oil is cold treated at the predetermined temperature with stirring to forming an evenly mixture of solid-type and liquid-type oil.

9. The processing method for poultry oil as claimed in claim 8, wherein the crude poultry oil is stirred at 5 rpm for at least 12 hours.

10. The processing method for poultry oil as claimed in claim 1, further comprising selecting the crude poultry oil from crude chicken, duck, goose, or ostrich oil before placing the crude poultry oil at the predetermined temperature.

11. The processing method for poultry oil as claimed in claim 1, wherein the predetermined temperature is set at 13° C. or 17° C., with a tolerance of ±0.5° C., and the liquid-type oil has a melting point of 13° C. or 17° C.

12. The processing method for poultry oil as claimed in claim 11, wherein a fatty acid ratio of the liquid-type oil is close to an ideal dietary fatty acid ratio proposed by Hayes (saturated fatty acid:monounsaturated fatty acid:polyunsaturated fatty acid (S:M:P)=1:1.5:1), a fatty acid ratio of human adipose tissue (S:M:P=1:1.9:0.7) or a combination thereof.
